(19) United States
(12) Patent Application Publication
(10) Pub. No.: US 2025/0124037 A1
(43) Pub. Date: Apr. 17, 2025

(54) SYSTEMS AND METHODS FOR GENERATING INSIGHTS AND SPARKING COLLABORATION THROUGH A KNOWLEDGE GRAPH OF BIOLOGICAL EXPERIMENTS

(71) Applicant: ROSALIND, Inc., San Diego, CA (US)

(72) Inventors: Benjamin Good, San Diego, CA (US); Jean Lozach, San Diego, CA (US); Timothy Wesselman, San Diego, CA (US); Jeremy Davis-Turak, San Diego, CA (US); Aaron Stanz, San Diego, CA (US)

(21) Appl. No.: 18/919,244

(22) Filed: Oct. 17, 2024

Related U.S. Application Data
(60) Provisional application No. 63/590,861, filed on Oct. 17, 2023.

(51) Int. Cl. G06F 16/2457; G06N 5/02

(52) U.S. Cl. CPC G06F 16/2457; G06N 5/02

(57) ABSTRACT

A knowledge graph that relates experiments, factors, results, and scientists to provide users with new insights and new opportunities for collaboration. This system includes a plurality of representative experiment groups that each include their own context data and result data. The system may accept a new experiment data set comprising new context data and new result data. This new experiment data set may then be compared with the data from the plurality of representative experiment groups to generate similarity scores. These similarity scores may be used to determine what relationships to create between the current data and other pre-existing data. Grouping the new experiment data set may generate connections between related experiments and data, as well as spark collaboration between scientists doing similar experiments.

### CROSS-REFERENCES TO RELATED APPLICATIONS

This application is a non-provisional and claims benefit of U.S. Patent Application No. 63/590,861, filed Oct. 17, 2023, the specification of which is incorporated herein in its entirety by reference.

### FIELD OF THE INVENTION

The present invention is directed to a knowledge graph that relates experiments, factors, results, and scientists to provide users with new insights and new opportunities for collaboration.

### BACKGROUND OF THE INVENTION

Academic scientists conduct hundreds of thousands of experiments every year with many of these eventually published in open-access repositories. At the same time, large organizations such as pharma companies, conduct thousands of experiments internally every year. The data produced by these experiments can provide valuable scientific insights—not just to the group that ran the experiment, but also to other scientists attempting to understand related aspects of biology. Given the increasingly large numbers of experiments in these collections, there exists a present need for new methods that can automatically connect scientists to the experiments that are most useful to them and to the other scientists who may form the most fruitful collaborators.

### BRIEF SUMMARY OF THE INVENTION

It is an objective of the present invention to provide systems and methods that allow for a knowledge graph that relates experiments, factors, results, and scientists to provide users with new insights and new opportunities for collaboration, as specified in the independent claims. Embodiments of the invention are given in the dependent claims. Embodiments of the present invention can be freely combined with each other if they are not mutually exclusive.

The present invention features a system for automatically generating relations between scientific data points in a knowledge graph database. In some embodiments, the system may feature one or more data sources. The system may further comprise a computing device communicatively coupled to the one or more data sources. The computing device may store a plurality of representative experiment groups, each representative experiment group comprising a prior experiment data set. In some embodiments, the computing device may be capable of accepting a new experiment data set from the one or more data sources. The computing device may be capable of accepting new context data and prior context data, generating a similarity structure for the new context data and the prior context data, and generating, based on the similarity structure, a context similarity score between the new context data and the prior context data. The computing device may be capable of processing new result data and prior result data, generating a comparison between a new initial data list and a prior initial data list, identifying, based on the comparison between the new initial data list and the prior initial data list, zero or more corresponding entities, generating a comparison between the new resulting data list and the prior resulting data list based on a ranking algorithm, generating, based on the comparison between the new initial data list and the prior initial data list and the comparison between the new resulting data list and the prior resulting data list, a result similarity score between the new result data and the prior result data, and adding the new experiment data set to the representative experiment group. The new experiment data set may be added to the representative experiment group based on the context similarity score and the result similarity score.

In some embodiments, the data list may contain genes, proteins, metabolites, or any other biological entity. In some embodiments, the results of the experiments may comprise gene expression, protein expression, genomic variants, methylation, or a combination thereof.

One of the unique and inventive technical features of the present invention is the automatic computerized generation of connections between biological experiments, research areas, and scientists through similarity scoring between representative groups. Without wishing to limit the invention to any theory or mechanism, it is believed that the technical feature of the present invention advantageously provides for a time- and resource-efficient method of sparking collaborations and identifying novel relationships between biological research to generate new discoveries in the field. None of the presently known prior references or work has the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows a schematic of a system for automatically generating relations between scientific data points in a knowledge graph database.

FIG. 2 shows a flow chart of a method for automatically generating relations between scientific data points in a knowledge graph database.

FIG. 3 shows a graphical model of an experiment as captured in the knowledge graph of the present invention.

FIG. 4 shows a diagram of computing semantic similarity for a pair of experiments.

FIG. 5 shows a diagram of a computing experiment similarity based on the correlation of result gene rankings.

FIG. 6 shows a diagram of expanding experiment-experiment relations using gene orthology.

FIG. 7 shows a diagram of similarity computations executed in parallel across many machines in a cluster.

FIG. 8 shows a diagram of sparking scientific collaboration using a graph of biological experiments.

### DETAILED DESCRIPTION OF THE INVENTION

Following is a list of elements corresponding to a particular element referred to herein:
100 computing device
110 Input Module
120 Context Similarity Module
130 Result Similarity Module
140 Search Module

The terms “orthologs” and “orthologous genes” are defined herein as genes in different species that originated by vertical descent from a single gene of the last common ancestor.

The term “Spearman rank correlation” is defined herein as a statistical measure of the strength of a monotonic relationship between paired data objects or data sets.

The term “monotonic relationship” is defined herein as a function that either never increases or never decreases as its independent variable increases.

The term “rank rank hypergeometric overlap” is defined herein as a comparison between gene expression signatures expressed as ranked lists based on expression differences between two classes of samples.

The term “rank-biased overlap” is defined herein as a similarity measure between indefinite/incomplete ranked lists, resulting in an expected average overlap value representing how similar the lists are.

The term “Running Fisher algorithm” is defined herein as an enrichment of ranked lists based on the Fisher exact test.

The term “OrderedList algorithm” is defined herein as a rank-based list comparison that examines multiple lists at a time.

The term “Comparison of Ranked Lists (CORaL) algorithm” is defined herein as a rank-based comparison of gene lists based on maximization of a similarity statistic.

The term “similarity structure” is defined herein as a framework that symbolically represents the similarity between two sets of data based on some factor.

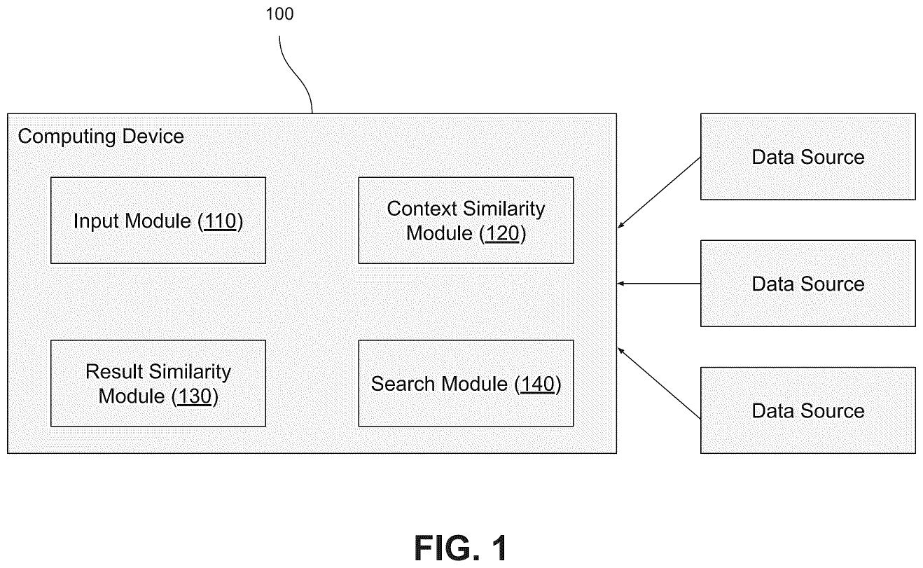

Referring now to FIG. 1, the present invention features a system for automatically generating relations between data points in a knowledge graph database. In some embodiments, the system may feature one or more data sources. The system may further comprise a computing device (100) communicatively coupled to the one or more data sources, the computing device (100) comprising a processor capable of executing computer-readable instructions and a memory component. In some embodiments, the memory component may comprise a plurality of representative experiment groups, each representative experiment group comprising a plurality of prior experiment data set, each prior experiment data set comprising a prior context data and a prior result data. The prior context data may comprise a prior set of context attributes. The prior result data may comprise a prior initial data list and a prior resulting data list.

The memory component may further comprise an Input Module (110). In some embodiments, the Input Module (110) may comprise computer-readable instructions for accepting a new experiment data set from the one or more data sources. The new experiment data set may comprise new context data and new result data. The new context data may comprise a new set of context attributes, and the new result data may comprise a new initial data list and a new resulting data list.

The memory component may comprise a Context Similarity Module (120). In some embodiments, the Context Similarity Module (120) may further comprise computer-readable instructions for accepting the new context data, and a prior context data from a representative experiment group of the plurality of representative experiment groups, generating a similarity structure for the new set of context attributes and the prior set of context attributes, and generating, based on the similarity structure, a context similarity score between the new context data and the prior context data.

The memory component may comprise a Result Correlation Module (130). In some embodiments, the Result Correlation Module (130) may comprise computer-readable instructions for accepting the new result data, and a prior result data from the representative experiment group, generating a comparison between the new initial data list and the prior initial data list, generating a comparison between the new resulting data list and the prior resulting data list based on a ranking algorithm, generating, based on the comparison between the new initial data list and the prior initial data list and the comparison between the new resulting data list and the prior resulting data list, a result similarity score between the new result data and the prior result data, and adding the new experiment data set to the representative experiment group thus allowing for the creation of new relationships in the database between the experiments. This would then enable discovery and collaboration between users via the user interface. The new experiment data set may be added to the representative experiment group based on the context similarity score and the result similarity score. In some embodiments, the memory component may further comprise a Search Module (140) comprising computer-readable instructions for querying the plurality of representative experiment groups based on textual input.

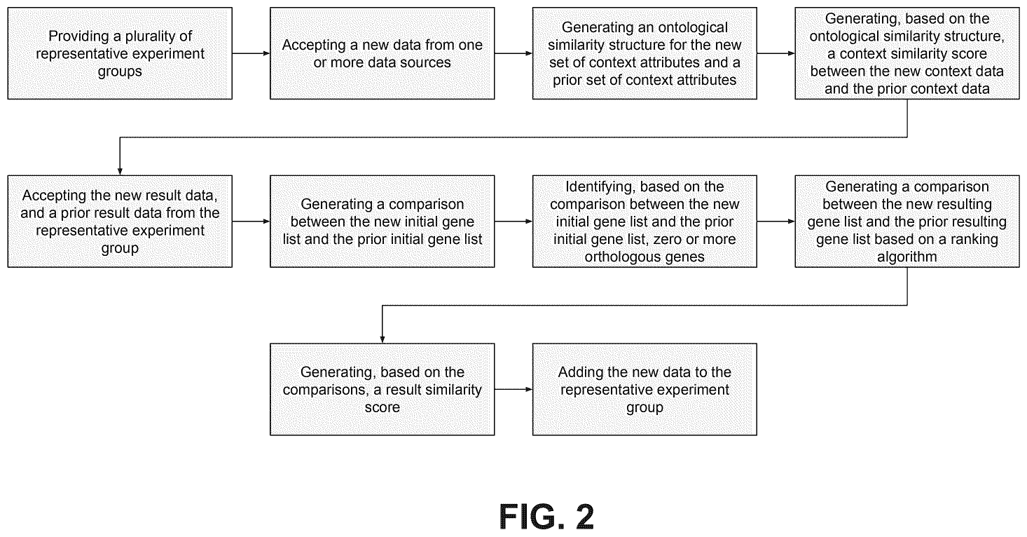

Referring now to FIG. 2, the present invention features a method for automatically generating relations between scientific data points in a knowledge graph database. In some embodiments, the method may comprise providing a plurality of representative experiment groups, each representative experiment group comprising a plurality of prior experiment data sets, each prior experiment data set comprising a prior context data and a prior result data. The prior context data may comprise a prior set of context attributes, and the prior result data comprises a prior initial data list and a prior resulting data list. The method may further comprise accepting a new experiment data set from one or more data sources. The new experiment data set may comprise new context data and new result data. The new context data may comprise a new set of context attributes, and the new result data may comprise a new initial data list and a new resulting data list.

The method may further comprise generating a similarity structure for the new set of context attributes and a prior set of context attributes from a prior experiment data set, generating, based on the similarity structure, a context similarity score between the new context data and the prior context data, and accepting the new result data, and a prior result data from the representative experiment group. The method may further comprise generating a comparison between the new initial data list and the prior initial data list, identifying, based on the comparison between the new initial data list and the prior initial data list, zero or more orthologous genes, and generating a comparison between the new resulting data list and the prior resulting data list based on a ranking algorithm. The method may further comprise generating, based on the comparison between the new initial data list and the prior initial data list and the comparison between the new resulting data list and the prior resulting data list, a result similarity score between the new result data and the prior result data, and adding the new experiment data set to the representative experiment group. The new experiment data set may be added to the representative experiment group based on the context similarity score and the result similarity score. In some embodiments, the method may further comprise querying the plurality of representative experiment groups based on textual input.

The present invention features a non-transitory computer readable storage medium for automatically generating relations between scientific data points in a knowledge graph database. In some embodiments, the non-transitory computer medium may comprise a computer readable code, which when executed by a processing computing device, causes the processing computing device to provide a plurality of representative experiment groups, each representative experiment group comprising a plurality of prior experiment data sets, each prior experiment data set comprising a prior context data and a prior result data. The prior context data may comprise a prior set of context attributes. The prior result data may comprise a prior initial data list and a prior resulting data list. The processing computing device may additionally accept a new experiment data set from one or more data sources. The new experiment data set may comprise new context data and new result data. The new context data may comprise a new set of context attributes. The new result data may comprise a new initial data list and a new resulting data list.

The processing computing device may additionally generate a similarity structure for the new set of context attributes and a prior set of context attributes from a prior experiment data set, and generate, based on the similarity structure, a context similarity score between the new context data and the prior context data. The processing computing device may additionally accept the new result data, and a prior result data from the representative experiment group, generate a comparison between the new initial data list and the prior initial data list, and generate a comparison between the new resulting data list and the prior resulting data list based on a ranking algorithm. The processing computing device may additionally generate, based on the comparison between the new initial data list and the prior initial data list and the comparison between the new resulting data list and the prior resulting data list, a result similarity score between the new result data and the prior result data.

The processing computing device may additionally add the new experiment data set to the representative experiment group, wherein the new experiment data set is added to the representative experiment group based on the context similarity score and the result similarity score. The processing computing device may additionally query the plurality of representative experiment groups based on textual input.

In some embodiments, the textual input may comprise one or more keywords associated with the experiment data, one or more words, phrases, and/or sentences found throughout the text of the experiment data, or a combination thereof. In some embodiments, the searching module and functionality of the present invention may be implemented as a dialogue-based interface module. The system and/or non-transitory computer medium may comprise a natural language processing model configured to accept input from the user, convert the input from natural language into a query, and search the stored experiment data using the query. Further input from the user may be used to filter the search or adjust the query.

Querying the plurality of representative experiment groups may be carried out by a Search Module. In some embodiments, the Search Module may support keyword-based search across the full collection of attributes associated with the experiments. A few example search terms would be “lung cancer”, “P53”, “angiotensin”, or other similar terms pertaining to biological research and experiments. The ontological structure of the knowledge graph may be leveraged to produce a ‘semantic search’ for experiments based on their contextual annotation. The search would also operate across the experiment results—e.g. if a gene was highly differentially expressed in a given experiment, the experiment could be found by the user based on searching for the gene or for a pathway that contained the gene.

In some embodiments, the new experiment data set and each prior experiment data set may further comprise one or more participating scientists. The system may be capable of relating and connecting these scientists working on related experiments, sparking collaboration between them. The plurality of representative experiment groups may be represented by an entity-relationship graph structure. In some embodiments, the entity-relationship graph structure may comprise a property-graph database.

In some embodiments, the prior set of context attributes may comprise species, anatomical location, tissue type, cell type, cell line, disease status, drug, treatment state, age, developmental stage, genetic background, phenotypes, clinical history, environmental history, diet and regimen, or a combination thereof. In some embodiments, the new set of context attributes may comprise species, anatomical location, tissue type, cell type, cell line, disease status, drug, treatment state, age, developmental stage, genetic background, phenotypes, clinical history, environmental history, diet and regimen, involved scientists, or a combination thereof. In some embodiments, the treatment state may comprise physical exercise, drug(s) used, any perturbation to the anatomical system, compound(s) used, dosages thereof, or a combination thereof.

The similarity structure may comprise a semantic similarity graph. The similarity structure may be generated based on a human curator, a natural language processing algorithm, or a combination thereof. The ranking algorithm may comprise a Spearman rank correlation, a rank-rank hypergeometric overlap, a Running Fisher algorithm, a rank-biased overlap algorithm, an OrderedList algorithm, a Comparison of Ranked Lists (CORaL) algorithm, gene ontology, a combination thereof, or any algorithm capable of ranking similarity between pairs of ordered lists.

The Gene Ontology (GO) is a focus of investigation of semantic similarity in molecular biology, not only because it is the ontology most widely adopted by the life sciences community, but also because comparing gene products at the functional level is crucial for a variety of applications. Semantic similarity applied to the GO annotations of gene products provides a measure of their functional similarity. The term “functional similarity” is used when referring to the similarity between two gene products given by the semantic similarity between the sets of GO terms with which they are annotated. As such, the semantic similarity measures and the studies reviewed in this article are presented in the context of GO, notwithstanding the fact that they are applicable to other biological ontologies.

GO provides a schema for representing gene product function in the cellular context. The GO is structured as three directed acyclic graphs (DAGs) that correspond to orthogonal categories of gene product function: molecular function, biological process, and cellular component. The nodes in the graph represent terms that describe components of gene product function. GO links the terms to each other by relationships, most commonly of the types ‘is a’ and ‘part of’, the former expressing a simple class-subclass relationship and the latter expressing a part-whole relationship. Gene products that are described by GO terms are said to be annotated with them, either directly or through inheritance, since annotation to a given term implies annotation to all of its ancestors (true path rule). The Gene Ontology Consortium is responsible for developing and maintaining GO terms, their relationships, and their annotations to genes and gene products of the collaborating databases. Moreover, GO Consortium is also responsible for developing tools that support the creation, maintenance, and use of all this information.

There are essentially two types of approaches for comparing terms in a graph-structured ontology such as GO: edge-based, which use the edges and their types as the data source; and node-based, in which the main data sources are the nodes and their properties. Note that there are other approaches for comparing terms that do not use semantic similarity—for example, systems that select a group of terms that best summarize or classify a given subject based on the discrete mathematics of finite partially ordered sets.

Edge-based approaches are based mainly on counting the number of edges in the graph path between two terms. The most common technique, distance, selects either the shortest path or the average of all paths when more than one path exists. This technique yields a measure of the distance between two terms, which can be easily converted into a similarity measure. Alternatively, the common path technique calculates the similarity directly by the length of the path from the lowest common ancestor of the two terms to the root node.

While these approaches are intuitive, they are based on two assumptions that are seldom true in biological ontologies: (1) nodes and edges are uniformly distributed, and (2) edges at the same level in the ontology correspond to the same semantic distance between terms. Several strategies have been proposed to attenuate these issues, such as weighting edges differently according to their hierarchical depth, or using node density and type of link. However, terms at the same depth do not necessarily have the same specificity, and edges at the same level do not necessarily represent the same semantic distance, so the issues caused by the aforementioned assumptions are not solved by those strategies.

Node-based approaches rely on comparing the properties of the terms involved, which can be related to the terms themselves, their ancestors, or their descendants. One concept commonly used in these approaches is information content (IC), which gives a measure of how specific and informative a term is. The IC of a term c can be quantified as the negative log likelihood, −log p(c), where p(c) is the probability of occurrence of c in a specific corpus (such as the UniProt® Knowledgebase), being normally estimated by its frequency of annotation. Alternatively, the IC can also be calculated from the number of children a term has in the GO structure, although this approach is less commonly used.

The concept of IC can be applied to the common ancestors two terms have, to quantify the information they share and thus measure their semantic similarity. There are two main approaches for doing this: the most informative common ancestor (MICA technique), in which only the common ancestor with the highest IC is considered; and the disjoint common ancestors (DCA technique), in which all disjoint common ancestors (the common ancestors that do not subsume any other common ancestor) are considered.

Approaches based on IC are less sensitive to the issues of variable semantic distance and variable node density than edge-based measures, because the IC gives a measure of a term's specificity that is independent of its depth in the ontology (the IC of a term is dependent on its children but not on its parents). However, the IC is biased by current trends in biomedical research, because terms related to areas of scientific interest are expected to be more frequently annotated than other terms. Nevertheless, the use of the IC still makes sense from a probabilistic point of view: it is more probable (and less meaningful) that two gene products share a commonly used term than an uncommonly used term, regardless of whether that term is common because it is generic or because it is related to a hot research topic.

Other node-based approaches include looking at the number of shared annotations, that is, the number of gene products annotated with both terms; computing the number of shared ancestors across the GO structure; and using other types of information such as node depth and node link density (i.e., node degree) (“Semantic Similarity in Biomedical Ontologies,” Faria et al.

The present invention features a discovery platform & data hub for scientists. This web-based platform supports scientists in analyzing, storing and sharing the results of many different kinds of biological experiments. In a typical scenario, a scientist may execute an experiment in their laboratory, collect the often large-scale data produced in a set of files, load the files into the platform, and then interrogate the results on the platform. Often, results take the form of a list of genes or other biological entities that show differences between the control and test conditions in the experiment. Experiments and results are stored on the databases driving the platform.

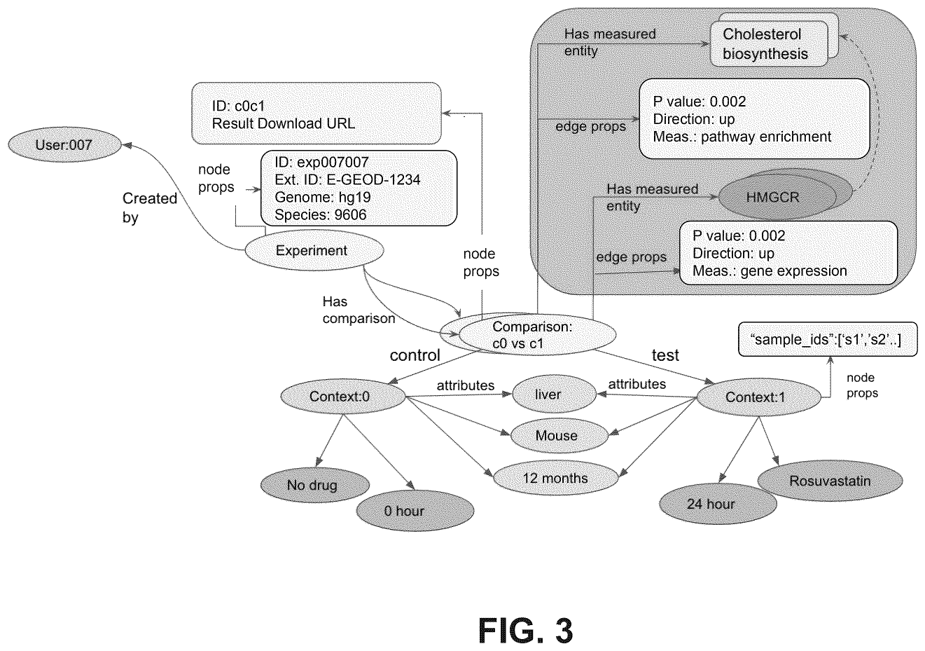

FIG. 3 illustrates the data model used to capture many experiments and results in the present invention. This model is currently implemented in a Neo4j® property-graph database, but may be reproduced in other property-graph structured databases (e.g. ArangoDB™, Amazon Neptune®, etc.), RDF databases (e.g. Blazegraph™, Virtuoso™, Stardog®, etc.), and indeed any system that supports an entity-relationship structure. A key feature of this model is the annotation of the different biological contexts that define the experimental conditions used to conduct a comparison. FIG. 3 shows a comparison between the context defined by {liver, mouse, 12 months, no drug, 0 hour} and the context defined by {liver, mouse, 12 months, Rosuvastatin, 24 hours}. These annotations are created using terms from an ontology that defines their meaning and relationships (e.g. Rosuvastin is_a Statin, etc.). The other key feature is the storage of the results of each comparison executed for an experiment. Here again, the results are captured using ontologies or other forms of controlled vocabulary.

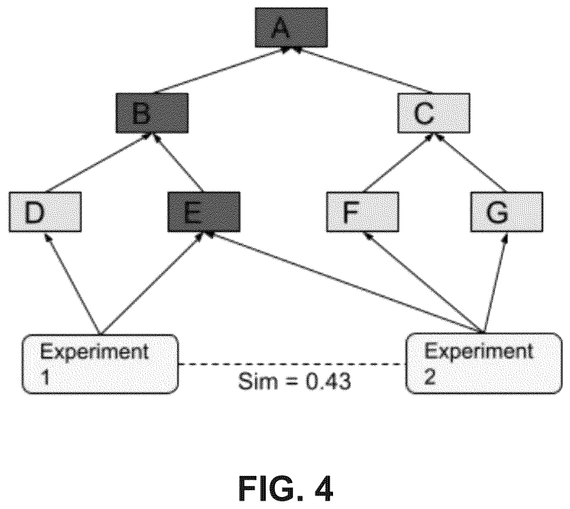

Referring now to FIG. 4, the present invention features a process for calculating a similarity score between two sets of experiment data. The boxes represent ontology-based annotations of biological context (e.g. disease, organism, cell type, etc.). In the depicted example, Experiment 1 encompasses {D, E, B, A} and Experiment 2 encompasses {F, E, G, C, A}. The darker boxes represent the intersection between the two experiments, {A, B, E}. The union of these two experiments is {A. B. C. D, E, F, G}. By dividing the size of the intersection by the size of the union, the Jaccard similarity value of these two experiments can be calculated as 0.43.

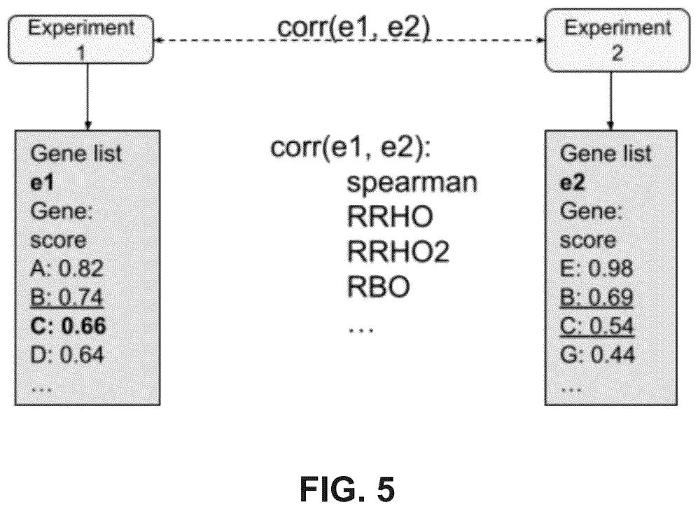

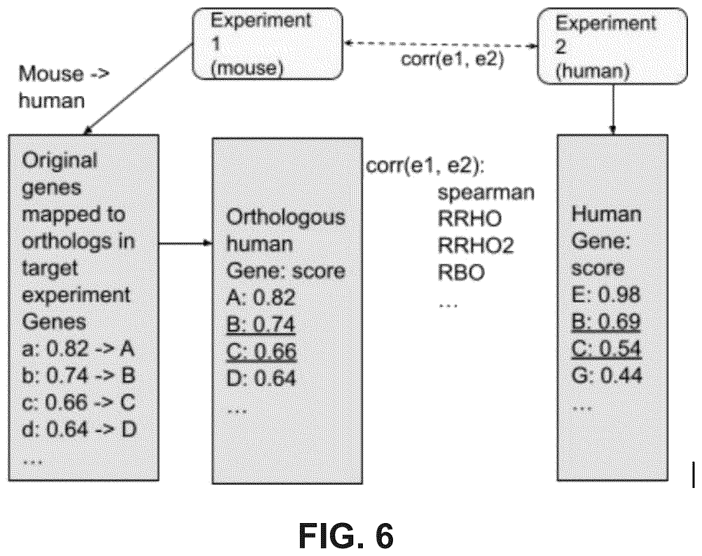

Referring now to FIG. 5, the present invention features a process for computing experiment similarity based on the correlation of result gene rankings. The resulting data lists of genes are ranked based on each gene's expression. A ranking algorithm (Spearman ranking, rank rank hypergeometric overlap (RRHO), a secondary rank rank hypergeometric overlap (RRHO2), rank-biased overlap (RBO), etc.). In some embodiments, experiments having different subjects may be compared based on orthologous genes, as seen in FIG. 6. The genes of the original organism are mapped to orthologous genes in the target organism that is shared with the other experiment. After this mapping process, the ranking and comparison process is carried out as usual.

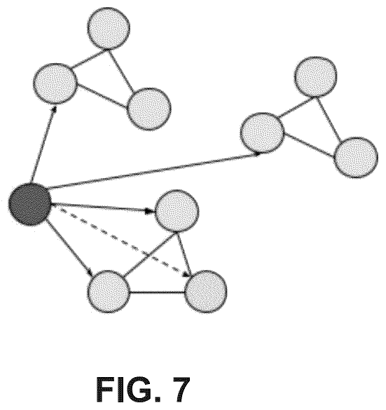

Referring now to FIG. 7, the present invention results in an improvement over prior knowledge graph comparison systems. In a naive system, input experiments are compared to all other experiments in order to find the best match, resulting in an N complexity process, where N is the total number of experiments in the knowledge graph. By implementing comparisons to representative experiment groups first, as depicted, the most likely place to find the most similar experiment is found first and a comprehensive search is only carried out in this cluster, greatly reducing the complexity of the search and improving the processing efficiency of the automated process.

The present invention stores collections of experiments and results in an access-controlled collaborative environment. This means scientists can choose to share their experiments with defined groups of other users of the platform such as members of their company. In addition to controlled-access data, the present invention provides access to collections of open-access experiments published in repositories such as the Gene Expression Atlas.

Using the computational representation of an experiment depicted in FIG. 3, it is possible to automatically compute relationships between experiments in terms of their results and the biological context in which they were conducted. This computation allows us to create a knowledge graph of biological experiments with many potential applications. The experiment graph is computed along 2 main axes: context similarity, and result correlation.

‘Biological context’, as used here, means the computational representation of all known aspects of the samples used in an experiment. These include, but are not limited to: species, anatomical location, tissue type, cell type, cell line, disease status, drug or other treatment state, age, developmental stage, genetic background, phenotypes, clinical history, and environmental history. These aspects may be referred to as experimental ‘factors’ or ‘attributes’ and are represented in computational form as classes in an ontology.

Representing the biological context of an experiment as a set of classes from an ontology allows for experiments to be compared to one another using a variety of semantic similarity metrics (e.g. information content, graph distance, cluster-based). These metrics provide a basis for quantifying the degree of similarity between experiments in terms of biological context.

Ontological structure can be used to expand the classes used to conduct the similarity measurements, e.g. including broader ancestor terms in the comparison in addition to the most specific annotations increases the chances of overlap, providing a broader range of coverage across a large pool of experiments. Using the ontology for this purpose, the present invention can compute the semantic similarity. There are many different algorithms that could be used for calculating a similarity score based on this structure. There are many different ways that this structure could be created. For example, a human curator using an existing ontology, a natural language processing (NLP) algorithm matching terms from the text of an experimental description to terms in an ontology, an NLP algorithm creating terms and ontology directly from the text, etc.

The results of many forms of biological experiments take the form of ranked lists of biological entities that show differences between the control and test conditions in an experiment. Rankings may be based, for example, on the amount of change observed between the experimental conditions for the expression of a gene. When two experiments produce measurements of the same entities (e.g. genes), the similarity of results of experiments can be assessed by comparing the rankings of those entities using a variety of metrics (Spearman rank correlation, rank-rank hypergeometric overlap, etc.). These metrics can thus be used to quantify the correlation or anticorrelation of experiments.

With potentially hundreds of thousands of experiments, there is a significant computational burden associated with computing the relationships between all experiments in the collection. To address this issue of scalability, the present invention can pre-compute the similarity and correlation relationships for a large number of experiments (e.g. those gathered from the public domain). Using these precomputed relationships the present invention can compute clusters or neighborhoods of similar experiments. For each cluster, the present invention can compute a representative experiment. New experiments can now be compared to this much smaller set of representative experiments first. Where some degree of matching is observed to a given representative experiment, the new experiment can then be compared to other experiments within the associated experiment cluster. This method will reduce the number of comparisons that need to be executed to find the most related experiments for an input experiment.

For any given experiment the present invention can rank other experiments in a collection in terms of contextual similarity and results. These rankings can be used to surface new insights related to the input experiment. While all computational tools for helping scientists gain insights from data are realized through the interactions between the scientist and the software and are thus not entirely predictable, the present invention can identify broad categories of the kinds of insights this system will help to generate. These categories vary along the two axes of similarity of context and results.

The experiments that are considered generate results in terms of thousands of dimensions. It is unlikely that either a high degree of correlation or anticorrelation would be observed by chance. (And this can be statistically quantified depending on the correlation method). Given that, a highly correlated pair of results from two different experiments is strong evidence that a similar biological program is being revealed by both experiments. At the same time, a highly anticorrelated result is also unlikely to be random and provides an indication that the biological program observed in one experiment is being specifically disrupted in the context of the anticorrelated experiment. An example of an expected anticorrelation would be the effect of a successful drug therapy on a disease signature. If the therapy is successful, it can reverse the biological program induced by the disease.

The physical samples that are the input to experiments come from specific biological contexts. By computationally annotating these contexts, the present invention can support custom searches for specific groups of experiments based on the qualities they share (boolean search, faceted search, etc.). and the present invention can combine the annotations to produce continuous measures of similarity. For any given experiment, the present invention can rank all the other experiments in the collection in terms of similarity—grouping along all or some of the dimensions. Two experiments with a high degree of contextual similarity share many attributes. They are likely performed in the same organism, tissue type, and disease status for example.

While results for experiments in similar contexts would generally be expected to exhibit some degree of correlation, sometimes one factor may drastically change the state of the organism and alter the results. In these cases, the small differences in experimental context can generate specific insights about the likely causes of the different results.

The combination of contextual and result similarity thus supports a powerful system for discovery. From any given experiment (especially from the user's own experiment which they know well and are the most interested in) the present invention can identify 4 broad categories of other experiments of interest: similar context and correlated results, different context and correlated results, similar context and anticorrelated results, different context and anticorrelated results, as seen in the table below.

| | Similar context | Different context |
|---|---|---|
| Correlated | Interpretation: the experiments | Interpretation: this exposes |
| results | provide additional data to | potentially novel |
| | support claims made from | connections between |
| | either experiment. | the different biological |
| | | contexts. |
| Anti- | Interpretation: if the degree | Interpretation: in general, |
| correlated | of context-similarity is | different biological |
| results | very high (e.g. it is | contexts would be |
| | effectively the same | expected to generate |
| | experiment) then anit- | uncorrelated results; |
| | correlated results could | however, if two different |
| | provide evidence to refute | biological contexts showed |
| | claims of the related | highly anticorrelated |
| | experiments. If the | results, this may also be |
| | experiments are related | scientifically interesting |
| | except for a small set of | because it would indicate |
| | differences (e.g. the same | a strong biological driver |
| | context with a drug | of the anti-correlation. |
| | perturbation), then anti- | Given the space of |
| | correlation can provide | potential results, it is |
| | very specific information | unlikely that any two |
| | about the impacts of | experiments would produce |
| | experimental factors that are | highly anticorrelated |
| | differing. A clear case of | results by chance. |
| | this would be one experiment | |
| | that identifies a distinct | |
| | signature for a disease and | |
| | another experiment that tests | |
| | a treatment for that disease. | |
| | If the results of the treatment | |
| | experiment are anti-correlated | |
| | with the disease signature, | |
| | that would be a positive | |
| | sign for the success of that | |
| | treatment. | |

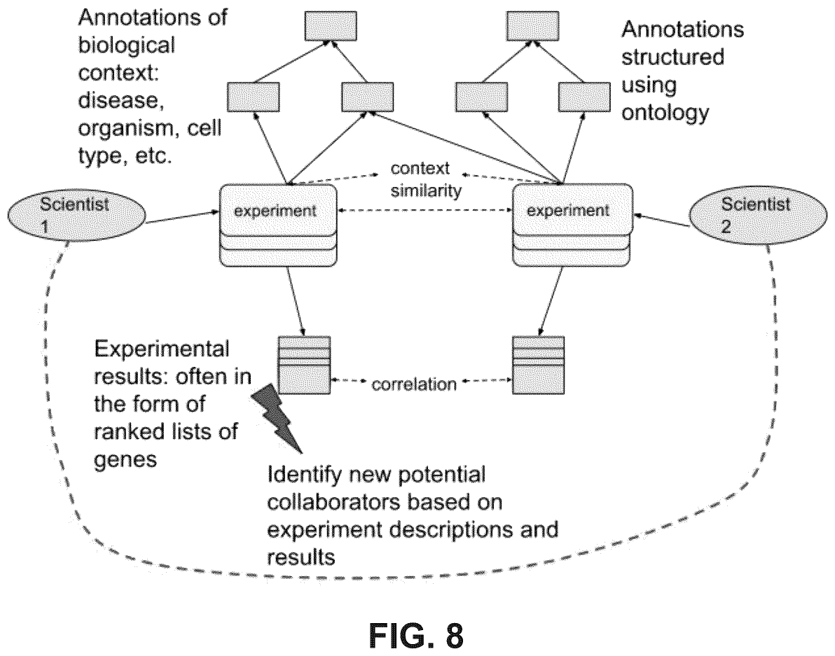

Apart from directly providing scientists with insights based on the placement of their experiment in relation to all the other experiments in the collection, a key use case for this system is to identify other scientists that may be fruitful collaborators. By adding scientists into the computed network of experiments, the present invention can identify connections between them using a variety of techniques. The present invention can find scientists working in similar/different biological contexts, with experiments whose results are correlated/anticorrelated and all such combinations (FIG. 8).

In some embodiments, the one or more data sources may comprise one or more external sources communicatively coupled to the present invention. These external sources may comprise university databases, scientific journals, clinic databases, individual studies, or a combination thereof. In some embodiments, the present invention may automatically scrape at least a portion of the new experiment data from the one or more sources such that links between the new experiment data and the representative experiment groups are generated as these new experiments are added to the sources. In some embodiments, the new experiment data may be directly submitted to the present invention. In some embodiments, at least a portion of the new experiment data may be submitted to the present invention by user input.

In some embodiments, the representative experiment groups may comprise experiments grouped by field, similar organisms, similar processes implemented, or some other factor. These representative experiment groups may be grouped and linked together in the overall knowledge graph. In some embodiments, the new experiment data may be linked to one representative group. In some embodiments, the new experiment data may be linked to more than one representative group. In some embodiments, the new experiment data may be more proximal to representative groups with which it shares a higher similarity score.

In some embodiments, the initial and resulting data lists may comprise lists of genes. The initial list may comprise the genes of an organism before any treatment has been applied. The resulting list may comprise the genes of an organism after treatment has been applied. Each of the genes in these individual lists may be ranked based on their expression.

In some embodiments, the similarity structure generated between the prior context data and the new context data may comprise an otological similarity structure. This structure may represent the dynamic and behavioral characteristics shared between two different experiments. In some embodiments, the similarity structure generated between the prior context data and the new context data may comprise a natural-language similarity structure. This structure may represent shared language between the texts of two experiments.

In some embodiments, the ranking algorithm may be preceded by a set-based correlation process. If two lists share more genes overall-without considering their rank-they are more likely to be correlated. This introduces potential for a two-step approach to accelerate the process. The ranked correlation between two sets may take longer to compute, so the set-based correlation process may be used to generate an initial approximate ranking to focus subsequent computing and speed up the process of finding the optimal ranking and correlation score. The resulting gene lists would be ranked, so the set-based correlation process may be used to unrank the lists into unranked sets that can be compared through set-based comparisons to find overlaps between them. First, quickly preselect the lists that have the highest potential for correlation, and then apply the full rank correlation algorithm to those selected lists. This process is used to filter the sets to determine objects of interest. The ranks are then reapplied and the rank correlation algorithms are applied only to the objects of interest, thus speeding up the computation process.

In some embodiments, the present invention may be configured to store data on experiments. In some embodiments, each experiment may comprise a collection of comparisons. In some embodiments, each comparison may link two sample groups from particular biological contexts defined by a set of characteristics and factors, with a goal of linking all characteristics to ontology. In some embodiments, the sample groups may comprise attributes that establish context, which are the same across all samples (e.g. species, tissue). In some embodiments, the factors may comprise attributes that determine comparison. The factors may be different across contexts (e.g. disease/normal, drug/no drug, time, etc.). In some embodiments, each experiment may comprise results that are statistically meaningful measurements discriminating the conditions.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A system for automatically generating relations between scientific data points in a knowledge graph database, the system comprising:
a. one or more data sources; and
b. a computing device (100) communicatively coupled to the one or more data sources, the computing device (100) comprising a processor configured to execute computer-readable instructions and a memory component operatively coupled to the processor, comprising:
i. a plurality of representative experiment groups, each representative experiment group comprising a plurality of prior experiment data sets, each prior experiment data set comprising prior context data and prior result data;
wherein the prior context data comprises a prior set of context attributes, wherein the prior result data comprises a prior initial data list and a prior resulting data list;
ii. an Input Module (110) comprising computer-readable instructions for:
A. accepting a new experiment data set from the one or more data sources;
wherein the new experiment data set comprises new context data and new result data, wherein the new context data comprises a new set of context attributes, wherein the new result data comprises a new initial data list and a new resulting data list;
iii. a Context Similarity Module (120) comprising computer-readable instructions for:
A. accepting prior context data from a representative experiment group of the plurality of representative experiment groups;
B. generating a similarity structure for the new set of context attributes and the prior set of context attributes; and
C. generating, based on the similarity structure, a context similarity score between the new context data and the prior context data; and
iv. a Result Correlation Module (130) comprising computer-readable instructions for:
A. accepting a prior result data from the representative experiment group;
B. generating a comparison between the new initial data list and the prior initial data list;
C. generating a comparison between the new resulting data list and the prior resulting data list based on a ranking algorithm;
D. generating, based on the comparison between the new initial data list and the prior initial data list and the comparison between the new resulting data list and the prior resulting data list, a result similarity score between the new result data and the prior result data; and
E. adding the new experiment data set to the representative experiment group, wherein the new experiment data set is added to the representative experiment group based on the context similarity score and the result similarity score.

2. The system of claim 1, wherein the memory component further comprises:
a. a Search Module (140) comprising computer-readable instructions for:
i. querying the plurality of representative experiment groups based on textual input.

3. The system of claim 1, wherein the new experiment data set and each prior experiment data set further comprise one or more participating scientists.

4. The system of claim 1, wherein the plurality of representative experiment groups is represented by an entity-relationship graph structure.

5. The system of claim 4, wherein the entity-relationship graph structure comprises a property-graph database.

6. The system of claim 1, wherein the prior set of context attributes comprises species, anatomical location, tissue type, cell type, cell line, disease status, drug, treatment state, age, developmental stage, genetic background, phenotypes, clinical history, environmental history, diet and regimen, involved scientists, or a combination thereof.

7. The system of claim 1, wherein the new set of context attributes comprises species, anatomical location, tissue type, cell type, cell line, disease status, drug, treatment state, age, developmental stage, genetic background, phenotypes, clinical history, environmental history, diet and regimen, involved scientists, or a combination thereof.

8. The system of claim 1, wherein the similarity structure comprises a semantic similarity graph.

9. The system of claim 1, wherein the similarity structure is generated based on a human curator, a natural language processing algorithm, or a combination thereof.

10. The system of claim 1, wherein the ranking algorithm comprises a Spearman rank correlation, a rank-rank hypergeometric overlap, a Running Fisher algorithm, a rank-biased overlap algorithm, an OrderedList algorithm, a Comparison of Ranked Lists (CORaL) algorithm, or a combination thereof, or any algorithm capable of ranking similarity between pairs of ordered lists.

11. A method for automatically generating relations between scientific data points in a knowledge graph database, the method comprising:
a. providing a plurality of representative experiment groups, each representative experiment group comprising a plurality of prior experiment data sets, each prior experiment data set comprising a prior context data and a prior result data;
wherein the prior context data comprises a prior set of context attributes, wherein the prior result data comprises a prior initial data list and a prior resulting data list;
b. accepting a new experiment data set from one or more data sources;
wherein the new experiment data set comprises new context data and new result data, wherein the new context data comprises a new set of context attributes, wherein the new result data comprises a new initial data list and a new resulting data list;
c. generating a similarity structure for the new set of context attributes and a prior set of context attributes from a prior experiment data set;
d. generating, based on the similarity structure, a context similarity score between the new context data and the prior context data;
e. accepting the new result data, and a prior result data from the representative experiment group;
f. generating a comparison between the new initial data list and the prior initial data list;
g. identifying, based on the comparison between the new initial data list and the prior initial data list, zero or more orthologous genes;
h. generating a comparison between the new resulting data list and the prior resulting data list based on a ranking algorithm;
i. generating, based on the comparison between the new initial data list and the prior initial data list and the comparison between the new resulting data list and the prior resulting data list, a result similarity score between the new result data and the prior result data; and
j. adding the new experiment data set to the representative experiment group, wherein the new experiment data set is added to the representative experiment group based on the context similarity score and the result similarity score.

12. The method of claim 11 further comprising:
a. querying the plurality of representative experiment groups based on textual input.

13. The method of claim 11, wherein the new experiment data set and each prior experiment data set further comprise one or more participating scientists.

14. The method of claim 11, wherein the plurality of representative experiment groups is represented by an entity-relationship graph structure.

15. The method of claim 14, wherein the entity-relationship graph structure comprises a property-graph database.

16. The method of claim 11, wherein the prior set of context attributes comprises species, anatomical location, tissue type, cell type, cell line, disease status, drug, treatment state, age, developmental stage, genetic background, phenotypes, clinical history, environmental history, diet and regimen, involved scientists, or a combination thereof.

17. The method of claim 11, wherein the new set of context attributes comprises species, anatomical location, tissue type, cell type, cell line, disease status, drug, treatment state, age, developmental stage, genetic background, phenotypes, clinical history, environmental history, diet and regimen, involved scientists, or a combination thereof.

18. The method of claim 11, wherein the similarity structure comprises a semantic similarity tree.

19. The method of claim 11, wherein the similarity structure is generated based on a human curator, a natural language processing algorithm, or a combination thereof.

20. The method of claim 11, wherein the ranking algorithm comprises a Spearman rank correlation, a rank-rank hypergeometric overlap, a Running Fisher algorithm, a rank-biased overlap algorithm, an OrderedList algorithm, a Comparison of Ranked Lists (CORaL) algorithm, a combination thereof, or any algorithm capable of ranking similarity between pairs of ordered lists.

21. A non-transitory computer-readable storage medium for automatically generating relations between scientific data points in a knowledge graph database comprising:
a. a computer-readable code, which when executed by a processing computing device, causes the processing computing device to:
i. provide a plurality of representative experiment groups, each representative experiment group comprising a plurality of prior experiment data sets, each prior experiment data set comprising a prior context data and a prior result data;
wherein the prior context data comprises a prior set of context attributes, wherein the prior result data comprises a prior initial data list and a prior resulting data list;
ii. accept a new experiment data set from one or more data sources;
wherein the new experiment data set comprises new context data and new result data, wherein the new context data comprises a new set of context attributes, wherein the new result data comprises a new initial data list and a new resulting data list;
iii. generate a similarity structure for the new set of context attributes and a prior set of context attributes from a prior experiment data set;
iv. generate, based on the similarity structure, a context similarity score between the new context data and the prior context data;
v. accept the new result data, and a prior result data from the representative experiment group;
vi. generate a comparison between the new initial data list and the prior initial data list;
vii. identify, based on the comparison between the new initial data list and the prior initial data list, zero or more orthologous genes;
viii. generate a comparison between the new resulting data list and the prior resulting data list based on a ranking algorithm;
ix. generate, based on the comparison between the new initial data list and the prior initial data list and the comparison between the new resulting data list and the prior resulting data list, a result similarity score between the new result data and the prior result data; and
x. add the new experiment data set to the representative experiment group, wherein the new experiment data set is added to the representative experiment group based on the context similarity score and the result similarity score.

22. The non-transitory computer medium of claim 21 further comprising computer readable code, which when executed by the processing computing device, causes the processing computing device to:
a. query the plurality of representative experiment groups based on textual input.

23. The non-transitory computer medium of claim 21, wherein the new experiment data set and each prior experiment data set further comprise one or more participating scientists.

24. The non-transitory computer medium of claim 21, wherein the plurality of representative experiment groups is represented by an entity-relationship graph structure.

25. The non-transitory computer medium of claim 24, wherein the entity-relationship graph structure comprises a property-graph database.

26. The non-transitory computer medium of claim 21, wherein the prior set of context attributes comprises species, anatomical location, tissue type, cell type, cell line, disease status, drug, treatment state, age, developmental stage, genetic background, phenotypes, clinical history, environmental history, diet and regimen, involved scientists, or a combination thereof.

27. The non-transitory computer medium of claim 21, wherein the new set of context attributes comprises species, anatomical location, tissue type, cell type, cell line, disease status, drug, treatment state, age, developmental stage, genetic background, phenotypes, clinical history, environmental history, diet and regimen, involved scientists, or a combination thereof.

28. The non-transitory computer medium of claim 21, wherein the similarity structure comprises a semantic similarity tree.

29. The non-transitory computer medium of claim 21, wherein the similarity structure is generated based on a human curator, a natural language processing algorithm, or a combination thereof.

30. The non-transitory computer medium of claim 21, wherein the ranking algorithm comprises a Spearman rank correlation, a rank-rank hypergeometric overlap, a Running Fisher algorithm, a rank-biased overlap algorithm, an OrderedList algorithm, a Comparison of Ranked Lists (CORaL) algorithm, a combination thereof, or any algorithm capable of ranking similarity between pairs of ordered lists.
